(19) United States
(12) Patent Application Publication
(10) Pub. No.: US 2020/0349640 A1
(43) Pub. Date: Nov. 5, 2020

(54) RISK ADJUSTED CASH FLOW

(71) Applicant: Zetatango Technology Inc., Mississauga (CA)

(72) Inventor: Peter Rabinovitch, Ottawa (CA)

(21) Appl. No.: 16/400,519

(22) Filed: May 1, 2019

(51) Int. Cl. G06Q 40/02; G06Q 20/10

(52) U.S. Cl. CPC G06Q 40/025; G06Q 20/105

(57) ABSTRACT

Calculating an interest rate for a loan comprises by receiving a credit score of a borrower and receiving a historical timeseries of balance data of the borrower. Determining a probability of default based on a modelling of the plurality of future balances. Transforming the historical timeseries into an implied timeseries based on a modelling of a plurality of future balances of the implied timeseries wherein the implied probability of default substantially equals the reference probability of default. Based on the implied timeseries, determining a worst-case plurality of future balances over the period of the loan and determining a worst-case probability of default. Based on the implied timeseries, determining a best-case plurality of future balances over the period of the loan and determining a best-case probability of default. Combining the worst-case probability of default and the best-case probability of default to calculate a risk adjusted interest rate for the loan.

### FIELD OF THE INVENTION

The present disclosure relates to the field of loan adjudications. In particular adjusting loan interest rates to obtain a desired rate of return.

### DESCRIPTION OF RELATED ART

In the financial services and loan industry, a lender will decide on an interest rate to charge a borrower that produces a desired rate of return. The interest rate typically takes into account the amount of risk involved, the amount of the loan, the term of the loan, and other factors. Usually, the most important risk factor is the chance that a borrower may default on the loan. Most lenders will evaluate the factors, make an estimate of the risk, and charge a risk adjusted interest rate to the borrower.

When estimating the risk of defaulting on the loan, analysis may take into account several data sources such as the borrower's credit score, cash flow, and other factors. Presently, this is performed in an ad hoc, often manual manner that varies depending on the person conducting the analysis. A common approach is to simply take a credit score and use the accompanying tables to determine an interest rate and an amount of money to lend. This method has the disadvantage that two individuals may have the same credit score but very different bank balances.

In other cases, a credit score together with a bank balance data may be used in a simplistic way. An example of this would be to calculate an average of the borrower's bank balance over the last 12 months or another period. This method has the additional disadvantage that an individual with a bank balance that is decreasing and a second individual with a bank balance that is increasing may be evaluated in the same way.

Each of these methods has the advantage of being simple but they tend to group potential borrowers into arbitrary categories that mis-classifies borrowers or produces inaccurate results in many cases.

There exists a need for a more accurate method to calculate a risk adjusted interest rate and a risk adjusted return by combining data sources and analyzing them in a consistent way.

### BRIEF SUMMARY

A major aspect of the invention includes a method of calculating an interest rate for a loan. The method comprises receiving a credit score of a borrower where the credit score comprises a reference probability of default based on the credit score. Receiving a historical timeseries of balance data of the borrower and based on the historical timeseries, modelling a plurality of future balances over a period of the loan. Determining a probability of default based on a modelling of the plurality of future balances. Transforming the historical timeseries into an implied timeseries by determining an implied probability of default based on a modelling of a plurality of future balances of the implied timeseries wherein the implied probability of default substantially equals the reference probability of default. Based on the implied timeseries and modelling a plurality of payments, determining a worst-case plurality of future balances over the period of the loan and determining a worst-case probability of default. Based on the implied timeseries, determining a best-case plurality of future balances over the period of the loan, a principal of the loan being added to the best-case plurality of future balances, and determining a best-case probability of default. Calculating a weighted sum of the worst-case probability of default and the best-case probability of default and utilizing the weighted sum to calculate a risk adjusted interest rate for the loan.

In further embodiments, the implied probability of default is determined by the percent of the plurality of future balances of the implied timeseries that become negative value.

In other embodiments, the worst-case probability of default is determined by the percent of the worst-case plurality of future balances that become negative.

In other embodiments, the best-case probability of default is determined by a number of the second plurality of future balances that have a negative value.

In yet other embodiments, the worst-case probability of default is determined on the best-case plurality of future balances that have a negative value.

Other embodiments utilize the risk adjusted interest rate to calculate a risk adjusted expected return on the loan.

Other aspects and features of the present invention will become apparent to those ordinarily skilled in the art upon review of the following description of specific embodiments of the invention in conjunction with the accompanying figures.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a loan adjudication process 100 in accordance with one embodiment.

FIG. 2 illustrates a loan adjudication method 200 in accordance with one embodiment.

FIG. 3 illustrates a bank balance history 300 in accordance with one embodiment.

FIG. 4 illustrates an initial bank balance forecast 400 in accordance with one embodiment.

FIG. 5 illustrates an initial balance of the bank account 500 in accordance with one embodiment.

FIG. 6 illustrates a probability of default based on their cash flow excluding any effect of the loan principal 600 in accordance with one embodiment.

FIG. 7 illustrates a probability of default based on their cash flow assuming that the principal is added to their balance 700 in accordance with one embodiment.

FIG. 8 illustrates a risk adjusted payments vs the risk adjusted rates 800 in accordance with one embodiment.

### DETAILED DESCRIPTION

Embodiments of the invention according to a first major aspect comprise methods to determine a risk adjusted cash flow and corresponding risk adjusted interest rate for a loan or similar financial instrument. The method may be used by a lender, borrower, or other stakeholder. It may also be used by other parties offering a service to determine risk adjusted cash flows and recommend interest rates to charge to obtain a desired rate of return for the lender.

The borrower may be a consumer, company, business, or other organization.

The lender may be a financial institution, merchant, or any other lending party.

The method may be implemented using computer hardware, software, and networks within a financial institution such as a bank, credit union, government, fund, trust fund, foundation, and other similar organization. The method may also be implemented by third parties such as banks, credit bureaus, and others providing a service or “Software as a Service” (SaaS). Within this document, the term adjudicator 118 is used in referring to the party or parties that perform the method according to embodiments of the invention.

Information concerning the borrower comprises credit rating information and financial transaction information including debits and credits as may be found on bank account statements. This information may be held by the party performing the method or be obtained through electronic transfer from the holders of this information. Transfer of information may be done through any type of appropriate computer network including the Internet (wired or wireless) or cellular networks. Data may be anonymized to remove personal identity information such as names, addresses, telephone numbers, etc. Actual account numbers may be used, or a substitute identification number or text string may be used.

Credit ratings, also referred to as credit scores, may be in any proprietary format, or from one of the major credit bureaus in their format or an industry standard, or open format.

In some embodiments, credit score is used as an implied probability of default as it is commonly used in commerce when deciding loan interest rates and an amount to lend. However, in other embodiment a credit score may substituted with any other indicator of an initial probability of default. This could be an average default rate by industry or geographic region. This could also be an average rating for demographic groups such as students, professional bodies, etc.

The method estimates a probability of the borrower defaulting on a loan. Typically, this is defined as being 90 days or more in arrears over a two-year period although other definitions and time spans may be used.

Using the method, transaction information from bank accounts are used as a timeseries. The timeseries is used by a model to estimate a large number of possible future bank balances over the term of the loan. It is assumed that these bank balances will be used to make payments on the loan. This is used to estimate a probability of default on the loan as it is assumed that if the bank balance goes negative, payments cannot be made, and the loan will be defaulted on.

The term bank account and bank balance are used to represent a single bank account, multiple bank account, accounts receivable, and other liquid assets that may be used to make loan payments of the principal and interest over the term of the loan.

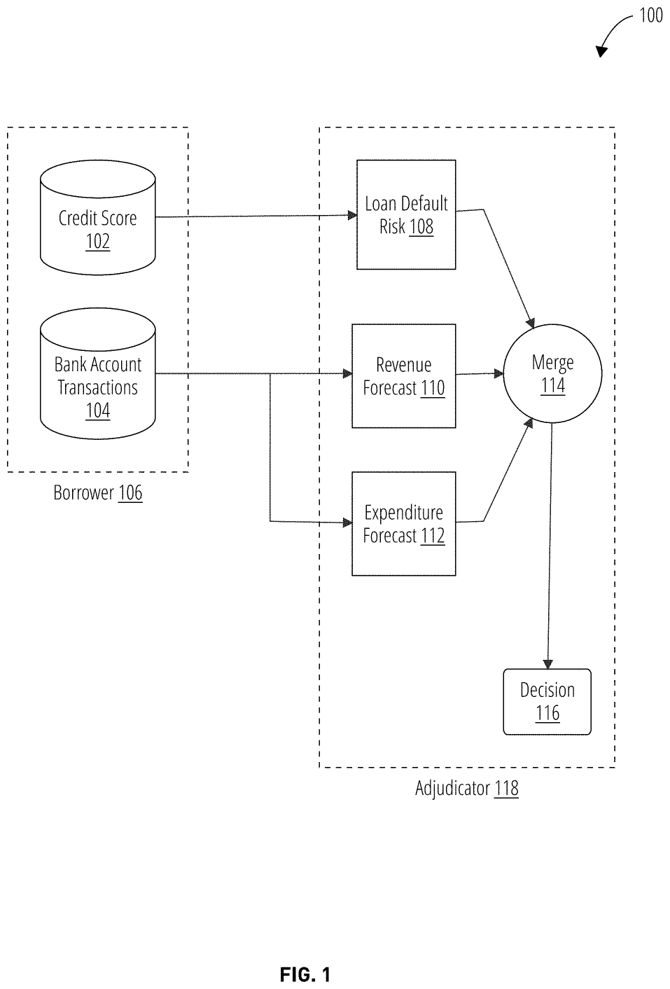

FIG. 1 provides a high-level view of embodiments of the invention. Embodiments utilize borrower 106 data from at least two sources, credit score 102 data and bank account transactions 104. At the adjudicator, the credit score 102 is utilized in the calculation of a reference loan default risk 108. The bank account transactions 104 are used to calculate both a revenue forecast 110 and expenditure forecast 112 as required. The credit score 102, revenue forecast 110, and expenditure forecast 112 are merge 114 to produce a decision 116 that may include a risk adjusted interest rate and a risk adjusted payment to be received by the lender. The risk adjusted payment may be used by the lender to ensure that their target return is achieved.

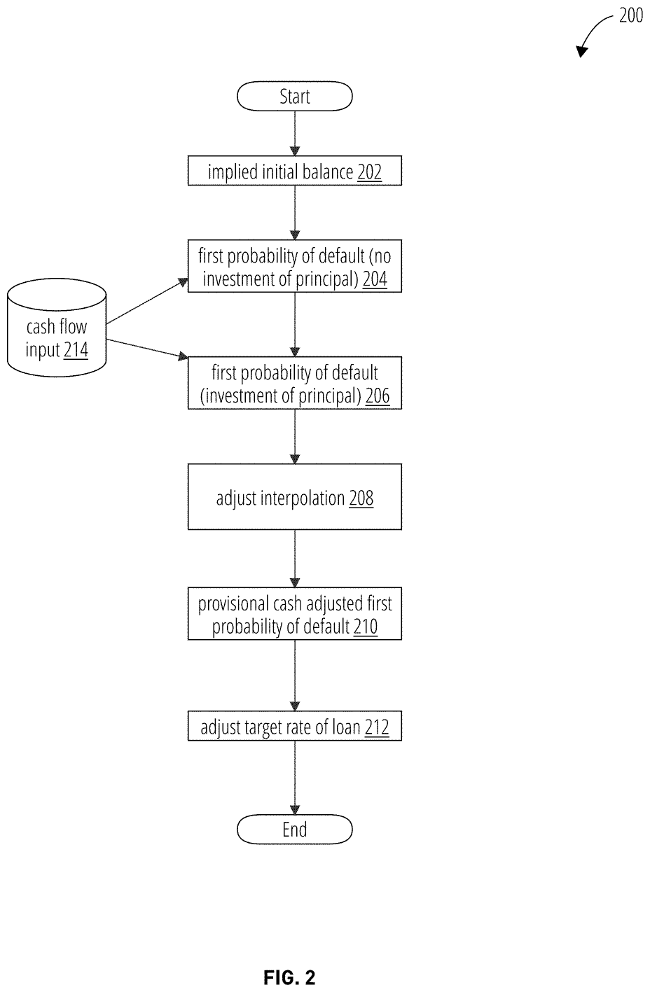

Referring to FIG. 2, in block 202, before looking at specifics of any loan offer (i.e. principal, payments, etc.) an implied initial balance is computed for the borrower's relevant bank accounts. The implied initial balance may be different from the actual initial balance. This implied initial balance is computed so that the businesses probability of default matches that of its credit score. The method uses the credit score as in indication of all available information about the business and barring any new information (such as another loan), under their current bank profile. The credit score is utilized as a reference or predictor of the businesses default probability. This is similar to an “efficient market hypothesis” as applied to credit scores. (The efficient market hypothesis is the economic theory that share prices of a business are a reflection of all available information on that business.)

In block 204, a first probability of default is calculated based on the borrower's cash flow ignoring the principal and excluding it from the bank balance. The borrower's cash flow changes when each loan payment is made, thereby increasing their debits, while credits are not affected. It also does not change the balance at the start of the loan.

In block 206, a first probability of default is calculated based on the borrower's cash flow assuming they deposit the principal of the loan in their bank account and then leave it untouched. For simplicity, it also assumes that no interest is received by the borrower on the loan principal. The borrower's cash flow changes when they have a loan payment to make, thereby increasing their debits. At the same time, the borrower's balance at the start of the loan period is incremented by the principal.

In block 208 and interpolation between the above two probabilities of default is made. The respective weighting of each value may be adjusted over time to obtain a provisional cash adjusted probability of default.

In block 210, the cash adjusted probability of default is used to adjust the interest rate of the loan in order to compensate for the increased risk.

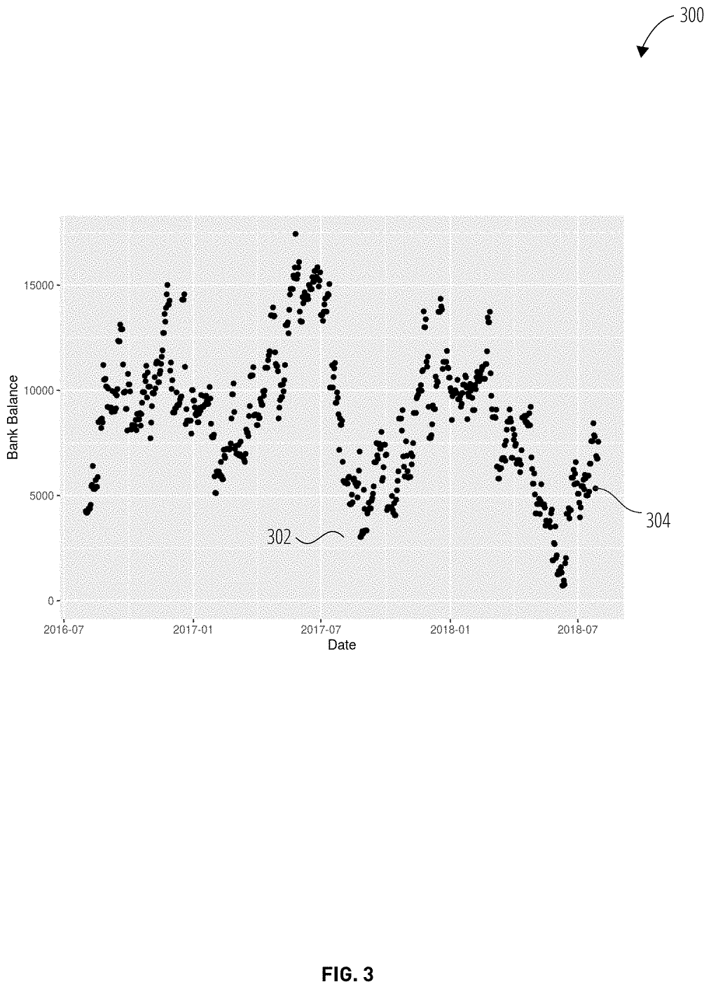

Referring to FIG. 3, the graph illustrates an example bank balance history 300 for an exemplary borrower with an initial bank balance 304 of approximately $5,000. The x-axis is the date, while the y-axis is the historical bank balance data 302 on that date.

In this example, we now assume the borrower is looking for a loan with a principal of 10,000 dollars and a term of 90 days. As calculated from the borrower's credit rating, their probability of default over the next two years is reported to be 0.02. Also as reported with their credit rating, their probability of default over the term of the loan is 0.0024658. The target interest rate of the lender is assumed to be 0.2.

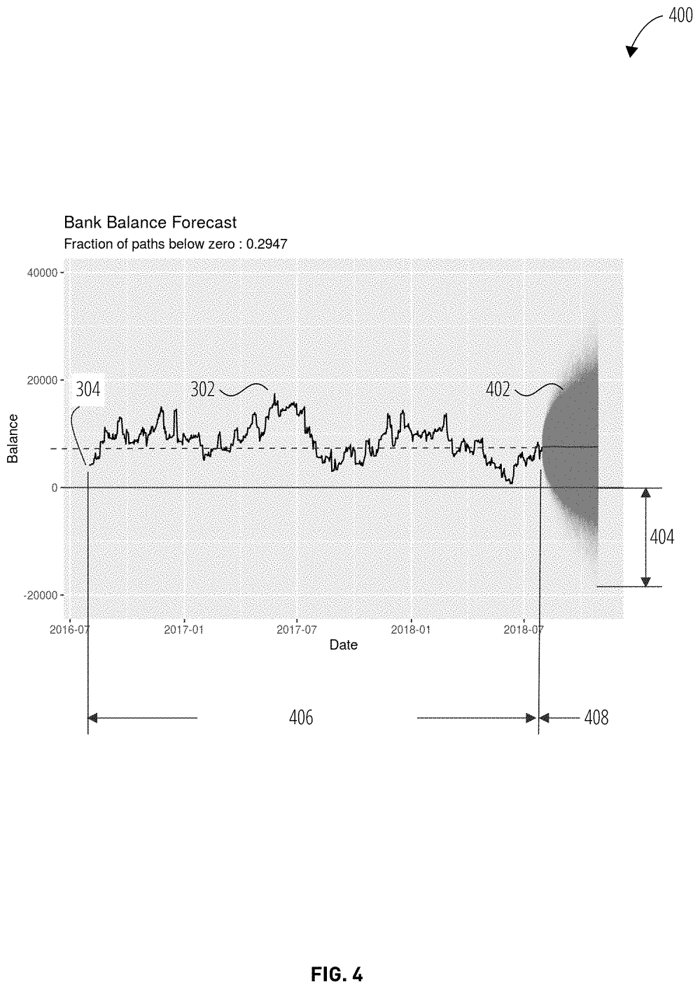

Referring to FIG. 4, the borrower's predicted bank balance data 402 is modelled, starting at the present date, until the end of the term of the loan. As shown in FIG. 3, the graph illustrates the borrower's historical bank balance data 302 (x-axis) on each date up to the date of the initial bank balance 304, from which the modelling of future balances starts. The date of the initial bank balance 304 is typically a date in the past from when relevant data is available. This date may be as far in the past as possible given that the borrower's business conditions at that date is comparable to today. For practical purposes, this will be 12 or 18 months. The further in the past the historical bank balance data 302 is, the narrower the confidence interval of the modelled data will be. However, by going too far back in time, the historical bank balance data 302 may not be relevant. For example, if the borrower merged with another company 8 months ago the historical bank balance data 302 before that date may no longer be relevant.

From the date modelling starts, predicted bank balance data 402 is modelled. Historical bank balance data 302 forms a time sequence and is used to obtain or configure a model and then simulate a large number of possible predicted bank balance data 402 outcomes. In some embodiments, an Arima (autoregressive integrated moving average) model and analysis is used to calculate these possible outcomes. Other similar models may be used.

The predicted future balance model is executed a large number of times so that statistically significant results are obtained. Each execution of the model produces an predicted future balance over the term of the loan. In some embodiments, the model will be executed as many as 10,000 times to produce 10,000 independent, modelled paths. The calculation is performed in software on computer workstations, servers, virtual machines, or another suitable computer hardware. Sufficient computing power must be used in order for the method to return results within a few seconds in order to be usable for a lender to make decisions for a borrower at, for example, a checkout counter in a store, or a bank teller's kiosk or desk.

From FIG. 4 it can be observed that some of the predicted bank balance data 402 results have paths that indicate predicted negative bank balances 404. It is then possible to calculate the fraction of paths, a total number of calculated paths, that lead to predicted negative bank balances 404, in this case 0.2947. A path that becomes negative at any time during the term of the loan may be used to predict a default on the loan.

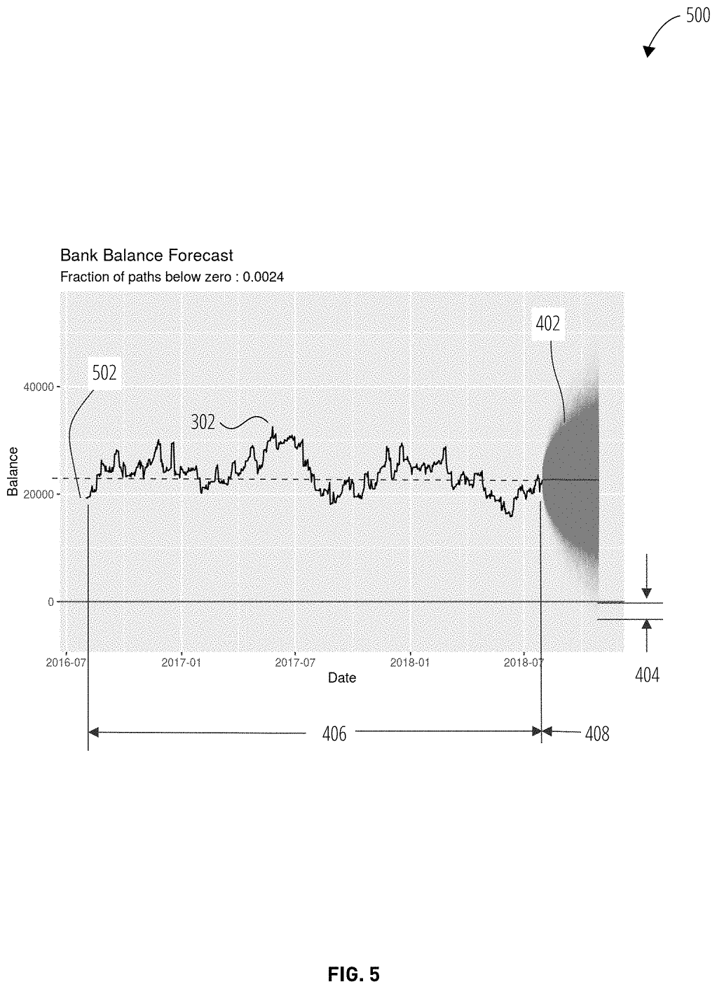

FIG. 5 is used to illustrate block 202, the first step of the loan adjudication method 200 in FIG. 2. The initial bank balance 304 is shifted so that the fraction of predicted negative bank balances 404 that go below zero is equal to the probability of default over the term of the loan predicted by the borrower's credit score, in this example, 0.0024658. The initial bank balance 304 may then be calculated and is observed in this example to be approximately $20,000. This value becomes the implied initial bank balance 502.

This produces a default probability of default based on the predicted bank balance data 402 based on the borrower's historical bank balance data to be consistent with the credit score value for the borrower.

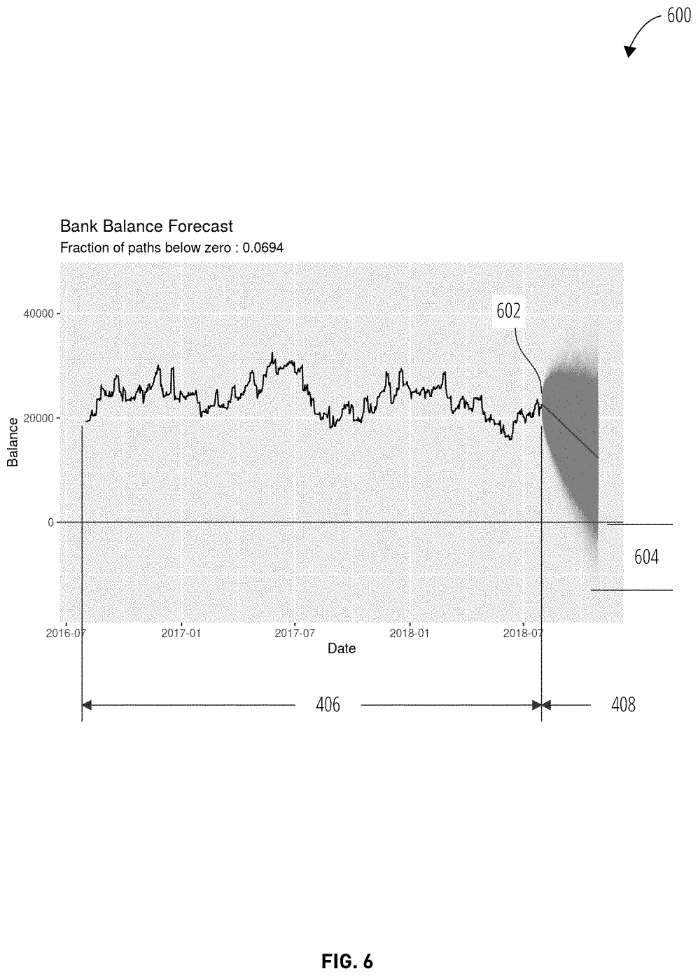

FIG. 6 is used to illustrate block 204, the second step of the loan adjudication method 200 in FIG. 2, where the probability of default based on their cash flow excluding any effect of the loan principal 600 is calculated. In this case, the borrower's cash flow changes only when they have a payment on the loan to make. The principle of the loan is ignored and not taken into account in the modelled future bank balance. This increases their bank account debits and decreases their balance, without affecting their credits or bank balance at the start of loan 602 (as the principal is ignored). This represents a worst-case scenario that with provide a lower bound on the probability of default on the loan.

Taking into account the loan payment over the term of the loan, the predicted future balance is modelled a large number of times so that statistically significant results are obtained. In some embodiments, as many as 10,000 modelled paths will be calculated.

In our example, the resulting worst-case probability of default 604 is now increased to 0.0694 from the value of 0.0024658 shown in FIG. 5

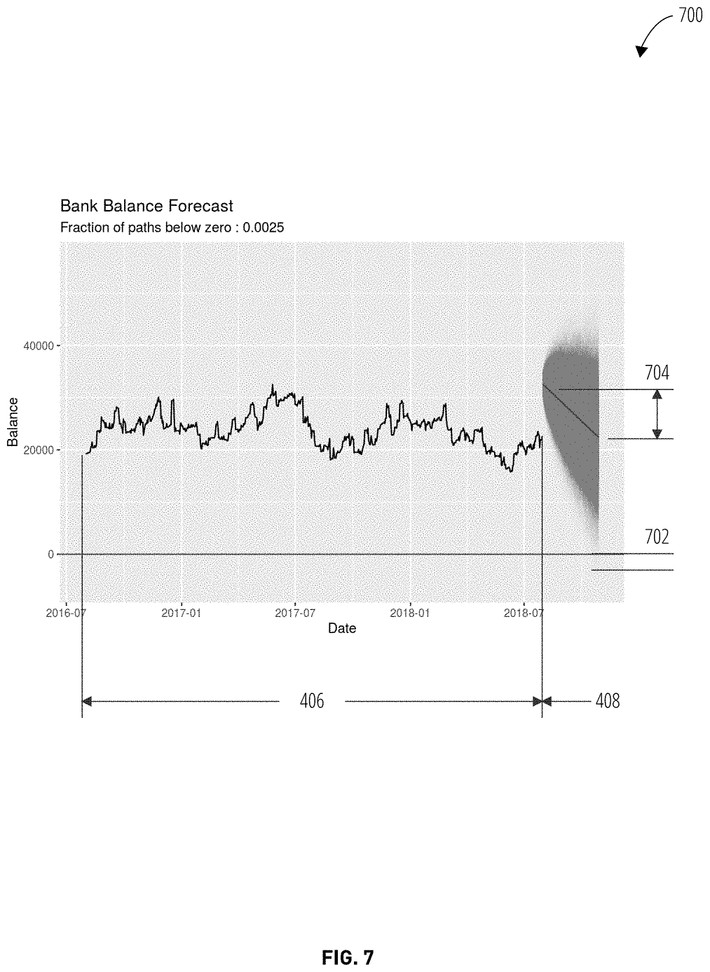

FIG. 7 is used to illustrate block 206, the third step of the loan adjudication method 200 of FIG. 2 where the probability of default based on their cash flow assuming that the principal is added to their balance 700 is calculated. In this case, the principal of the loan 704 is added to the borrower's bank balance at the start of the loan. The borrower's cash flow changes only when they have a new payment on the loan to make. Taking into account the loan payment over the term of the loan, the predicted future balance is modelled a large number of times so that statistically significant results are obtained. In some embodiments, as many as 10,000 modelled paths will be calculated. In our example, the resulting best-case probability of default 702 is modelled to be to 0.0025.

In the fourth step of the loan adjudication method 200, block 208 in FIG. 2, we interpolate between the worst-case probability of default 604 and the best-case probability of default 702. In some embodiments the interpolation is done as a weighted sum of the two value. The value of the slider or weighting may be adjusted over time as more data is obtained. The slider is a value between 0 and 1 and represents the weighting of the worst-case probability of default. Correspondingly, the weighting of the best-case probability of default becomes 1−slider. The interpolated value is used to obtain a provisional cash adjusted estimate of default probability at the present time.

In our example, the worst-case probability of default 604 is 0.0694. The best-case probability of default 702 is 0.0025. The interpolation method is a weighted sum of the two values. Using a slider value of 0.5 yields a cash adjusted default probability of 0.03595.

[(0.0694×slider)+(0.0025×(1−slider)]

The fifth step of the loan adjudication method 200, block 210 in FIG. 2, determines a provisional cash adjusted probability of default. This probability of default may be used to estimate what the interest rate should be to ensure a risk adjusted interest rate equal to the target return desired by the lender is obtained.

The probability that a loan defaults, b, at any time over the term of the loan is assumed to have a uniform probability distribution. In the case of a default, no further payments are made, and no further interest payments are received. Thus, the average amount lost is m/2 where m is the loan principal.

On the other hand, with probability 1−b the full loan is paid back, and further the interest, i, is paid. For simplicity, it is assumed that no interest is paid to the lender in case of default. Then the expected value (average) of what is returned, v, is:

$$v = ( 1 - b ) \times i - \frac{b / m}{2}$$

Solving for i, gives us the interest rate that should be charged to obtain an expected return that matches the lenders target.

$$i = \frac{v}{1 - b} + \frac{b}{1 - b} \frac{m}{2}$$

In the above equation, the cash adjusted probability of default, b, is used to adjust the interest rate, i, on the loan from the target rate in order to compensate for the increased risk.

Recall that the original target rate for the loan was 0.2, so the new rate, the one we will use to price the loan, is 0.3550557. For this loan, the unadjusted payment was 113.903787, and the new risk adjusted payment will be 116.0998465.

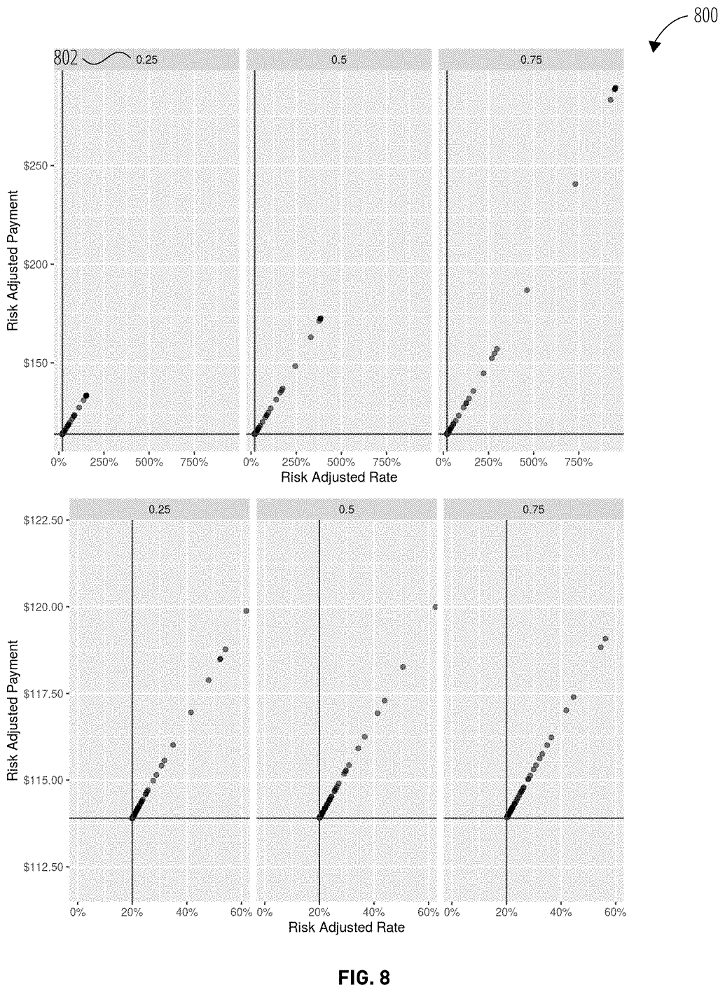

FIG. 8 illustrates risk adjusted payments vs the risk adjusted rates 800 for three values of the slider 802. It can be seen in the top 3 panels that some calculations result in very high risk adjusted rates. In the bottom 3 panels, only results with a risk adjusted rate below 60% are shown to reflect that if the risk of default is too high, as indicated by very high risk adjusted rates, that lender will not issue the loan.

What is claimed is:

1. A method of calculating an interest rate for a loan, the method comprising:
receiving a credit score of a borrower, the credit score comprising a reference probability of default based on the credit score;
receiving a historical timeseries of balance data of the borrower, based on the historical timeseries, modelling a plurality of future balances over a period of the loan;
determining a probability of default based on a modelling of the plurality of future balances;
transforming the historical timeseries into an implied timeseries by determining an implied probability of default based on a modelling of a plurality of future balances of the implied timeseries wherein the implied probability of default substantially equals the reference probability of default;
based on the implied timeseries and modelling a plurality of payments, determining a worst-case plurality of future balances over the period of the loan and determining a worst-case probability of default;
based on the implied timeseries, determining a best-case plurality of future balances over the period of the loan, a principal of the loan being added to the best-case plurality of future balances, and determining a best-case probability of default;
calculating a weighted sum of the worst-case probability of default and the best-case probability of default and utilizing the weighted sum to calculate a risk adjusted interest rate for the loan.

2. The method of claim 1 wherein the implied probability of default is determined by the percent of the plurality of future balances of the implied timeseries that become negative.

3. The method of claim 1 wherein the worst-case probability of default is determined by the percent of the worst-case plurality of future balances that become negative.

4. The method of claim 1 wherein the best-case probability of default is determined by a number of the second plurality of future balances that have a negative value.

5. The method of claim 4 wherein the worst-case probability of default is determined on the best-case plurality of future balances that have a negative value.

6. The method of claim 1 further comprising utilizing the risk adjusted interest rate to calculate a risk adjusted expected return on the loan.
